(19) United States
(12) Patent Application Publication
(10) Pub. No.: US 2011/0053617 A1
(43) Pub. Date: Mar. 3, 2011

(54) PAGING METHOD IN COMMUNICATION SYSTEM

(75) Inventors: Namsuk Lee, Daejeon (KR); Sook Jin Lee, Daejeon (KR)

(73) Assignee: Electronics and Telecommunications Research Institute, Daejeon (KR)

(21) Appl. No.: 12/868,046

(22) Filed: Aug. 25, 2010

(30) Foreign Application Priority Data
Aug. 26, 2009 (KR) 10-2009-0079320
Jul. 28, 2010 (KR) 10-2010-0073027

(51) Int. Cl. H04W 68/00

(52) U.S. Cl. 455/458

(57) ABSTRACT

In order for a femto cell base station located within an area of a macro cell base station to provide a paging service to a terminal, the femto cell base station receives paging information from the macro cell base station having the same paging group ID as that of the femto cell base station. Then, common paging area information including paging information is transmitted to the terminal, and when a paging message is received from a paging controller, the received paging message is transmitted based on the common paging area information to the terminal, thereby providing a paging service to the terminal.

### CROSS-REFERENCE TO RELATED APPLICATION

This application claims priority to and the benefit of Korean Patent Application Nos. 10-2009-0079320 and 10-2010-0073027 filed in the Korean Intellectual Property Office on Aug. 26, 2009 and Jul. 28, 2010, the entire contents of which are incorporated herein by reference.

### BACKGROUND OF THE INVENTION

(a) Field of the Invention

The present invention relates to a method for providing a paging service in a broadband wireless communication system supporting a femto cell.

(b) Description of the Related Art

A femto cell provides a radio service to a terminal in an area having a cell radius of approximately 30 meters. A femto cell base station, which is a small base station installed to support a femto cell within a macro cell, provides better signal quality than that of a macro cell base station in an area where houses or offices are clustered.

In a broadband wireless communication system, a terminal is provided with various services from a base station, and when services are terminated, the terminal enters an idle mode from the service activation state. The terminal is provided with a paging service and a location-based service in an idle mode from the base station.

When the terminal performs a procedure for entering the idle mode, the base station transmits information such as a temporary ID (TempID), a paging group ID (PGID) of the base station, a paging cycle, a paging offset, and the like, to the terminal in order to support the paging service or the location-based service.

Thus, the femto cell base station is expected to necessarily support the paging service to be provided to terminal in the same manner as the macro cell base station. In this case, the method for providing the paging service may be divided into various methods depending on how the paging group ID is allocated.

However, in some of the methods, when the terminal moves from the macro cell to the femto cell or from the femto cell to the macro cell, a procedure of updating the location of the terminal must be performed depending on how the paging service is supported. The location updating procedure is frequently performed, which causes a problem in that signaling overhead increase. Also, in some methods, signal interference increases between the macro cell base station and the femto cell base station within the macro cell.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for providing a paging service having advantages of preventing occurrence of signal interference in transmitting a paging message while reducing the performing of a frequent location updating procedure in a wireless communication system.

An exemplary embodiment of the present invention provides a method for providing a paging service to a terminal by a femto cell base station located within an area of a macro cell base station, including:

receiving paging information from the macro cell base station having the same paging group ID as that of the femto cell base station; transmitting common paging area information including the paging information to the terminal; receiving a paging message from a paging controller; and transmitting the received paging message to the terminal base on the common paging area information.

Another embodiment of the present invention provides a method for receiving a paging service by a terminal in a communication system in which a femto cell base station and a macro cell base station coexist, including:

transmitting a base station registration request message to the femto cell base station; receiving common paging area information from the femto cell base station; and receiving a paging message from one of the femto cell base station or the macro cell base station.

### BRIEF DESCRIPTION OF THE DRAWINGS

FIG. 1 is an exemplary view showing a general paging method when a macro cell base station and a femto cell base station belong to different paging groups.

FIG. 2 is an exemplary view showing a general paging method when a macro cell base station and a femto cell base station belong to the same paging group.

FIG. 3 is a flowchart illustrating the general process of a paging procedure performed by a macro cell base station and a femto cell base station belonging to the same paging group.

FIG. 4 is a view showing a method of allocating a common paging area according to an exemplary embodiment of the present invention.

FIG. 5 is a flowchart illustrating a paging procedure using a common paging area according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the present disclosure, a terminal may be referred to as a mobile station (MS), a mobile terminal (MT), a subscriber station (SS), a portable subscriber station (PSS), user equipment (UE), an access terminal (AT), and the like, or may include entire or partial functions of the MT, SS, PSS, UE, and the like.

In the present disclosure, a base station (BS) may be referred to as an access point (AP), a radio access station (RAS), a Node B, a base transceiver station (BTS), a mobile multihop relay (MMR)-BS, and the like, and may include the entire or partial functions of the AP, RAS, Node B, BTS, MMR-BS, and the like.

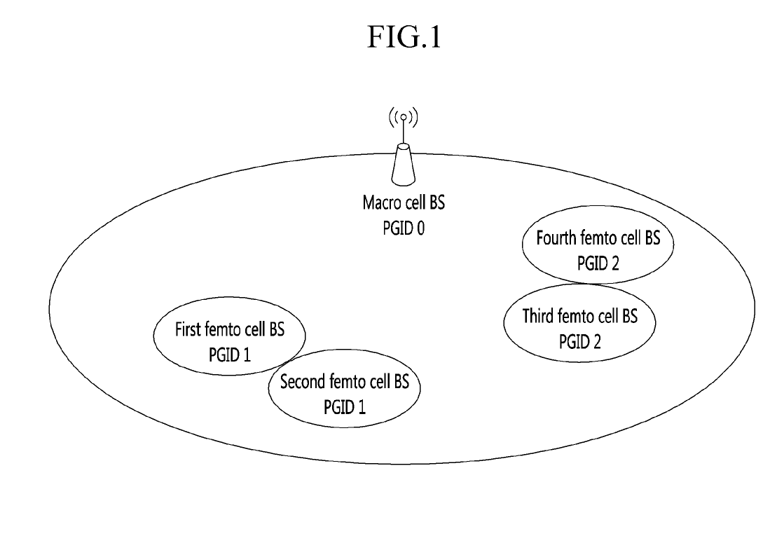

A paging method in a broadband wireless communication system supporting a femto cell according to an exemplary embodiment of the present invention will be described with reference to the accompanying drawings. Before describing an exemplary embodiment of the present invention, a general paging method in a communication system environment will be first described with reference to FIGS. 1 to 3.

FIG. 1 is an exemplary view showing a general paging method when a macro cell base station (BS) and a femto cell BS belong to different paging groups.

As shown in FIG. 1, when the macro cell BS and the femto cell BS belong to different paging groups, a terminal transmits a paging message only in the femto cell BS or the macro cell BS where the terminal is currently located. Accordingly, an unnecessary paging message transmission can be reduced.

In this state, when the terminal moves from the macro cell BS area to the femto cell BS area or from the femto cell BS area to the macro cell BS area, a procedure of updating location information of the terminal must to be performed. In this case, in general, the radius of the area of the femto cell BS is approximately 30 meters, so the procedure for updating the location information of the terminal is frequently conducted. The frequent terminal location information updating procedure leads to an increase in signal overhead.

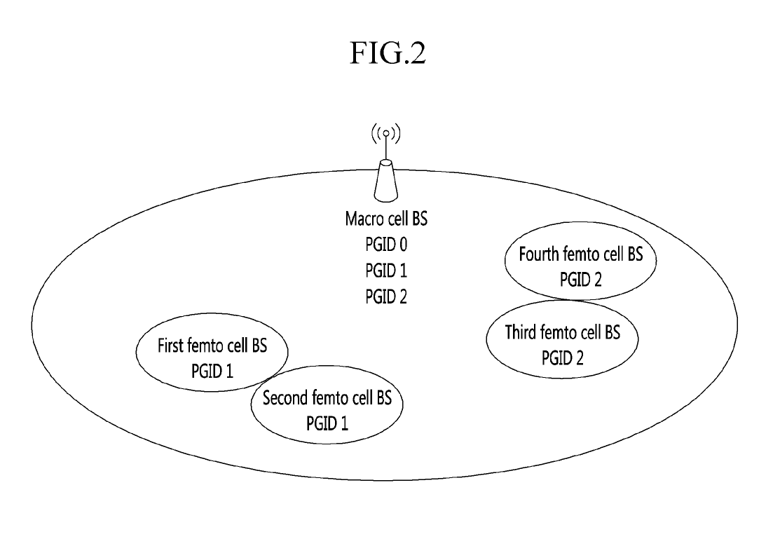

FIG. 2 is an exemplary view showing a general paging method when a macro cell base station and a femto cell base station belong to the same paging group. Specifically, FIG. 2 shows the case in which the same paging ID is allocated to a macro cell BS and a femto cell BS included in the area of the macro cell BS.

As shown in FIG. 2, because the femto cell BS and the macro cell BS have the same paging group ID, although the terminal moves between cells from the area of the femto cell BS to the area of the macro cell BS or from the area of the macro cell BS to the area of the femto cell BS, there is no need to perform the terminal location updating procedure.

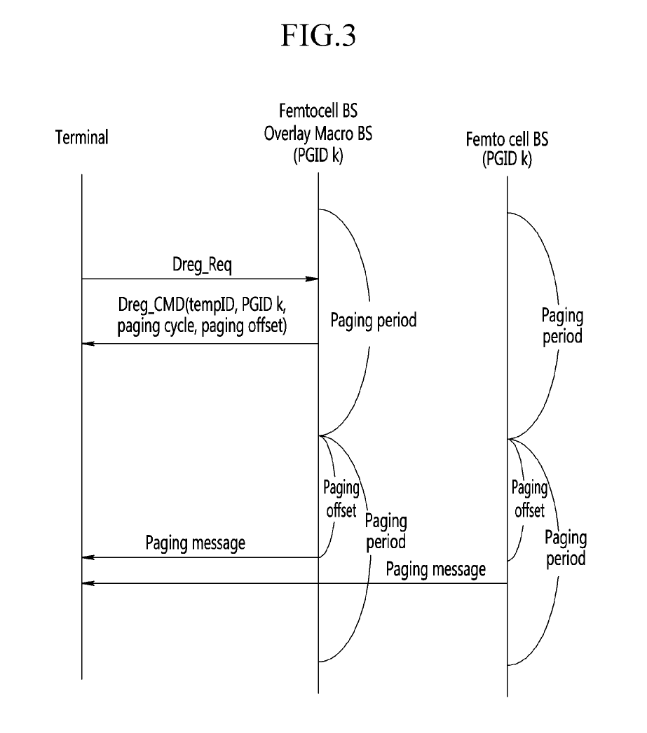

FIG. 3 is a flowchart illustrating the general process of a paging procedure performed by a macro cell base station and a femto cell base station belonging to the same paging group.

As shown in FIG. 3, the terminal located in the area of the femto cell BS receives a paging message that is periodically transmitted from the femto cell BS, by using a paging period and offset information that the femto cell BS has been allocated from the macro cell BS in a procedure of entering an idle mode. In this case, all the macro cell BSs and femto cell BSs belonging to the same paging group transmit the paging message based on the paging period and offset to the terminal, and accordingly, signal interference increases in the area of the macro cell BS.

Thus, an exemplary embodiment of the present invention proposes a paging method that is capable of preventing generation of signal interference while reducing the frequent occurrence of the procedure of updating location information of a terminal. To this end, in the exemplary embodiment of the present invention, it is assumed that a femto cell BS and a macro cell BS have the same paging group ID.

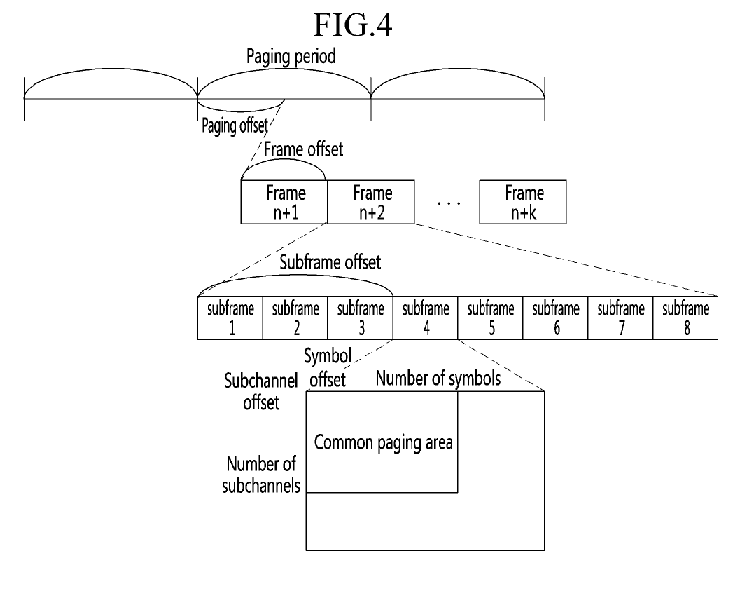

FIG. 4 is a view showing a method of allocating a common paging area according to an exemplary embodiment of the present invention.

As shown in FIG. 4, common paging area information generated by the macro cell BS includes information such as a paging group ID allocated to the macro cell BS itself, a paging period, a paging offset, a frame offset indicating a frame in the paging offset, a subframe offset in a frame, a symbol offset indicating a start position of a common paging area in a subframe, and a sub-channel offset. In addition, the common paging area information includes the number of symbols and the number of subchannels representing the size of the common paging area.

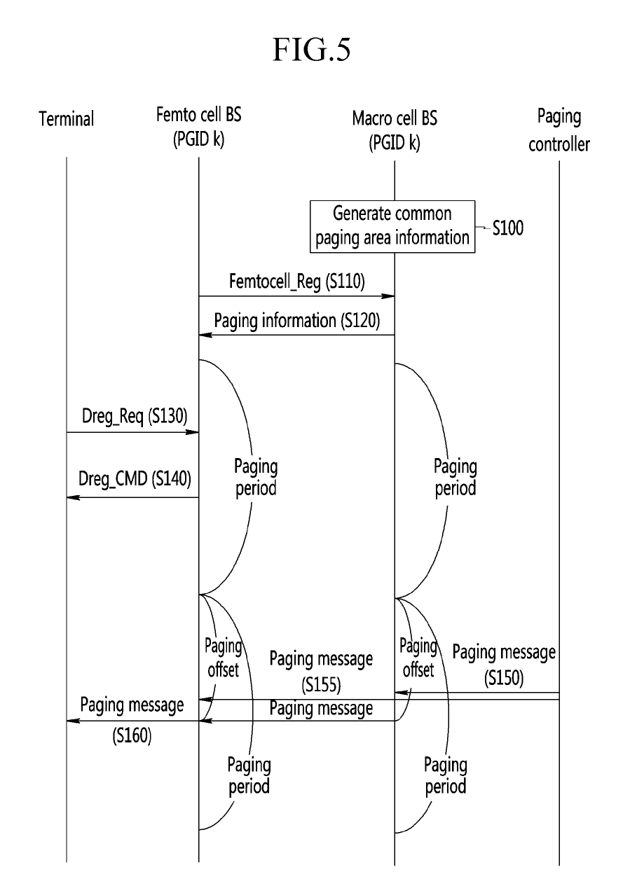

A method for providing a paging service by using the common paging area information described above with reference to FIG. 4 to the terminal that is to enter an idle state will now be described with reference to FIG. 5.

FIG. 5 is a flowchart illustrating a paging procedure using a common paging area according to an exemplary embodiment of the present invention.

As shown in FIG. 5, the macro cell BS generates the common paging area information (S100). Here, the common paging area information includes information such as a paging group ID, a paging period, a paging offset, a frame offset, a subframe offset, a symbol offset, and a subchannel offset. In addition, the common paging area information further includes the number of symbols and the number of subchannels.

In order for the femto cell BS to be located within the area of the macro cell BS, the femto cell BS transmits a BS registration request message (Femtocell_Reg) requesting BS registration to the macro cell BS (S110). In this case, the BS registration request message includes a femto cell BS ID, information regarding the location where the femto cell BS is installed, and the like.

Upon receiving the BS registration request message from the femto cell BS, the macro cell BS ascertains the presence of the femto cell BS within its area based on the location information of the femto cell BS and registers the femto cell BS. Then, the macro cell BS transmits the common paging area information and MCS information for a paging service to the femto cell BS (S120).

When the terminal located within the area of the femto cell BS wants to change its state into an idle mode, the terminal transmits a deregistration request message (Dreg_Req: Deregistration_Request) to the femto cell BS (S130). Upon receiving the deregistration request message from the terminal, the femto cell BS transmits a deregistration command message (Dreg_CMD) to the terminal (S140). Here, the deregistration command message includes the information such as the paging group ID, the paging period, and the paging offset allocated to the femto cell BS.

After the femto cell BS transmits the deregistration command message to the terminal, or according to the pre-set paging period, the femto cell BS and the macro cell BS receive a paging message from a paging controller, respectively (S150, S155). Then, the femto cell BS and the macro cell BS modulate and code the paging message according to a modulation coding scheme (MCS) previously designated in steps S100 and S120.

Thereafter, the femto cell BS and the macro cell BS transmit the modulated and coded paging message through the common paging area to the terminal, which has received the deregistration command message, in the idle mode (S160). In this case, when the femto cell BS transmits the paging message to the common paging area, the femto cell BS controls power according to the distance between the femto cell BS and the macro cell BS and then transmits the paging message. The method of controlling power has been known, so a detailed description thereof will be omitted. In this manner, because the femto cell BS and the macro cell BS modulate and code the same paging message according to the MCS and transmit the same to the terminal by using the common paging area, multiple gains can be obtained in the area of the macro cell BS area.

Meanwhile, when the terminal receives the deregistration command message from the femto cell BS, the terminal changes its state into an operation of the idle mode, and receives the paging message transmitted from the femto cell BS or the macro cell BS according to the paging period and paging offset information included in the deregistration command message (S160). At this time, the terminal is located within the area of the femto cell BS, and a main agent of a BS that transmits the paging message to the terminal is changed according to the location of the femto cell BS.

That is, when the femto cell BS is installed close to the macro cell BS, the femto cell BS transmits only paging message allocation information, rather than transmitting the paging message to the terminal by using the common paging area. Upon receiving the paging message allocation information, the terminal receives the paging message transmitted from the macro cell BS, based on the paging message allocation information.

In other words, the terminal located within the area of the femto cell BS receives the paging message transmitted to the common paging area, among signals transmitted from the macro cell BS, by using the paging message allocation information received from the femto cell BS. Here, the paging message allocation information relates to information regarding allocation of the common area to which the paging message is transmitted after being allocated by the macro cell BS.

However, if the femto cell BS is not installed close to the macro cell BS, the terminal receives the paging message transmitted by the femto cell BS. In this case, the distance between the femto cell BS and the macro cell BS, which enables the terminal located within the area of the femto cell BS to receive the paging message transmitted by the macro cell BS, can be arbitrarily set.

Meanwhile, when the macro cell BS wants to change the common paging area, the macro cell BS must transmit changed common paging area information to every femto cell BS within the area of the macro cell BS. The macro cell BS and the femto cell BS can use the remaining resource other than the resource that has been used to transmit the paging message in the common paging area to transmit other data.

According to the exemplary embodiments of the present invention, because a femto cell base station has the same paging group ID as that of the macro cell base station in the communication system in which a macro cell and a femto cell coexist, system overhead caused as a terminal frequently updates location information can be reduced.

In addition, because the macro cell base station transmits information regarding a common paging area to the femto cell base station, the macro cell base station and the femto cell base station can transmit a paging message to the same resource area, and thus signal interference between the macro cell base station and the femto cell base station is reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a paging service to a terminal by a femto cell base station located within an area of a macro cell base station, the method comprising:
receiving paging information from the macro cell base station having the same paging group ID as that of the femto cell base station;
transmitting common paging area information including the paging information to the terminal;
receiving a paging message from a paging controller; and
transmitting the received paging message to the terminal base on the common paging area information.

2. The method of claim 1, wherein the transmitting of the common paging area information comprises:
receiving a base station registration request message from the terminal; and
transmitting the common paging area information, wherein the common paging area information comprises modulation and coding scheme (MCS) information.

3. The method of claim 2, wherein the transmitting of the paging message comprises
modulating and coding the paging message based on the MCS information.

4. The method of claim 1, further comprising,
when the femto cell base station is located to be adjacent to the macro cell base station, transmitting paging message allocation information to the terminal, after the paging message is received.

5. The method of claim 4, wherein the paging message allocation information comprises the common paging area information.

6. The method of claim 5, wherein the common paging area information is set by the macro cell base station, and comprises at least one of a paging group ID, a paging period, a paging offset, a frame offset, a subframe offset, a symbol offset, a subchannel offset, the number of symbols, and the number of subchannels.

7. A method for receiving a paging service by a terminal in a communication system in which a femto cell base station and a macro cell base station coexist, the method comprising:
transmitting a base station registration request message to the femto cell base station;
receiving common paging area information from the femto cell base station; and
receiving a paging message from one of the femto cell base station and the macro cell base station.

8. The method of claim 7, further comprising:
receiving paging message allocation information from the femto cell base station, after the common paging common information is received; and
receiving the paging message from the macro cell base station based on the received paging message allocation information.

9. The method of claim 7, wherein the common paging area information comprises modulation and coding scheme (MCS) information, and the paging message is modulated and coded based on the MCS information.

10. The method of claim 7, wherein the receiving of the common paging area information comprises
receiving a registration release command message from the femto cell base station in response to the registration request message,
wherein the registration release command message comprises a paging group ID allocated to the femto cell base station, a paging period, and paging offset information.
